(19) United States
(12) Patent Application Publication
(10) Pub. No.: US 2026/0100745 A1
(43) Pub. Date: Apr. 9, 2026

(54) FULL POWER MODE 1 FOR PARTIALLY COHERENT 8 TX UE

(71) Applicant: TELEFONAKTIEBOLAGET LM ERICSSON (PUBL), Stockholm (SE)

(72) Inventors: Sven Jacobsson, Västra Frölunda (SE); Andreas Nilsson, Göteborg (SE)

(21) Appl. No.: 19/115,273

(22) PCT Filed: Nov. 3, 2023
(86) PCT No.: PCT/IB2023/061120

§ 371 Date: Mar. 26, 2025

Related U.S. Application Data
(60) Provisional application No. 63/422,668, filed on Nov. 4, 2022.

(51) Int. Cl. H04B 7/06; H04L 27/26

(52) U.S. Cl. CPC H04B 7/0639; H04L 27/261

(57) ABSTRACT

Systems and methods for full power transmission for a partially coherent Tx User Equipment (UE) are provided. In some embodiments, the UE receives a configuration that indicates a full power mode of operation; transmits reference signals from each antenna port group of two or more antenna port groups; receives an indication to use a precoder for the full power mode transmission where the indicated precoder indicates polarization and spatial direction for each of the port groups; and transmits a single layer using the indicated precoder on the two or more antenna port groups. In this way, the proposed solution enables full output power to be transmitted in UL for a set of precoders for an 8 Tx partially coherent UE with 2 or 4 antenna group, where the precoders take the spatial and polarization properties of the channel into account, which could improve the coverage and performance in UL.

### RELATED APPLICATIONS

This application claims the benefit of provisional patent application Ser. No. 63/422,668, filed Nov. 4, 2022, the disclosure of which is hereby incorporated herein by reference in its entirety.

### TECHNICAL FIELD

The present disclosure relates generally to determining a set of precoders.

### BACKGROUND

### Uplink (UL) Transmission/Precoding Schemes

The channel that carries data in the New Radio (NR) UL is called Physical Uplink Shared Channel (PUSCH). In NR, there are two possible waveforms that can be used for PUSCH: Cyclic Prefix-Orthogonal Frequency Division Multiplexing (CP-OFDM) and Discrete Fourier Transform Spread Orthogonal Frequency Division Multiplexing (DFT-S-OFDM). Also, there are two transmission schemes specified for PUSCH: Codebook (CB)-based precoding and Non-Codebook (NCB)-based precoding.

The gNB configures, in Radio Resource Configuration (RRC), the transmission scheme through the higher-layer parameter txConfig in the PUSCH-Config Information Element (IE). CB-based transmission can be used for non-calibrated User Equipments (UEs) and/or for Frequency Division Duplexing (FDD) (i.e., UI/Downlink (DL) reciprocity does not need to hold). NCB-based transmission, on the other hand, relies on UL/DL reciprocity and is, hence, intended for Time Division Duplexing (TDD).

### CB-Based Precoding

CB-based PUSCH is enabled if the higher-layer parameter txConfig is set to ‘codebook’. For dynamically scheduled PUSCH with configured grant type 2, CB-based PUSCH transmission can be summarized in the following steps:
1. The UE transmits Sounding Resource Signals (SRS), configured in an SRS resource set with higher-layer parameter usage in SRS-Config IE set to ‘codebook’. Up to two SRS resources (for testing up to two virtualizations/beams/panels) each with up to four ports, can be configured in the SRS resource set.
2. The gNB determines the number of layers (or rank) and a preferred precoder (i.e., TPMI) from a codebook subset based on the received SRS from one of the SRS resources. The codebook subset is configured via the higher-layer parameter codebookSubset, based on reported UE capability, and is one of
   fully coherent (‘fullyAndPartialAndNonCoherent’), or
   partially coherent (‘partialAndNonCoherent’), or
   non-coherent (‘nonCoherent’),
3. If two SRS resources are configured in the SRS resource set, the gNB indicates the selected SRS resource via a 1-bit SRI field in the Downlink Control Information (DCI) scheduling the PUSCH transmission. If only one SRS resource is configured in the SRS resource set, the SRI field is not indicated in DCI.
   The gNB indicates, via DCI, the number of layers and the Transmit Precoder Matrix Indication (TPMI). Demodulation Reference Signal (DM-RS) port(s) associated with the layer(s) are also indicated in DCI.
4. The UE performs PUSCH transmission over the antenna ports corresponding to the SRS ports in the indicated SRS resource.

Precoding information and number of layers, for 4 antenna ports, if transform precoding is disabled and maxRank=2, 3 or, 4 can be found in Table 7.3.1.1.2-2 of 3GPP TS 38.212. Precoding information and number of layers, for 4 antenna ports, if transform precoding is disabled/enabled and maxRank=1 can be found in Table 7.3.1.1.2-3 of Third Generation Partnership Project (3GPP) Technical Specification (TS) 38.212. Precoding information and number of layers, for 2 antenna ports, if transform precoding is disabled and maxRank=2 can be found in Table 7.3.1.1.2-4 of 3GPP TS 38.212. Precoding information and number of layers, for 2 antenna ports, if transform precoding is disabled/enabled and maxRank=1 can be found in Table 7.3.1.1.2-5 of 3GPP TS 38.212. Precoding matrix, W, for single-layer transmission using four antenna ports when transform precoding is disabled can be found in Table 6.3.1.5-3 of 3GPP TS 38.211. Precoding matrix, W, for four-layer transmission using four antenna ports when transform precoding is disabled can be found in Table 6.3.1.5-7 of 3GPP TS 38.211.

### UL Full Power Mode in Rel-16

### UE Power Amplifier (PA) Implementations

From a UE PA implementation point of view, the Rel-15 power scaling specification may have benefits since it limits the required output power per PA at the UE. For example, for a 4 port UE, regardless of rank, coherence capability, and precoder selection, the power scaling scheme makes sure that a maximum of P_{CMAX}/4 is required from respective PA (assuming one PA per antenna port at the UE). This makes it cheaper to implement the UE, since low power PAs are cheaper than high power PAs. However, if a 4-port UE is equipped with one or more PAs with higher output power than P_{CMAX}/4, then Rel-15 power scaling will limit the potential of utilizing the extra output power. To handle this, it was agreed in Rel-16 that three different UE PA architectures (referred to as capabilities, even though it is not strictly ‘capabilities’ and may not directly indicate maximum PA power on each of the UE's Transmit (Tx) chains) should be considered when specifying the Rel-16 power scaling modes, as illustrated schematically in FIG. 1. For Capability 1, all PAs (Tx chains) at the UE should be able to transmit with the maximum allowed output power P_{CMAX}, for Capability 2, none of the PAs can transmit at P_{CMAX}, and for Capability 3, a subset of the PAs can transmit with P_{CMAX}. Note that the PAs not being able to transmit with P_{CMAX}, can transmit with any output power below P_{CMAX}. Release 15 power scaling was mainly designed for Capability 2 UEs.

Three different full power modes have been specified in Rel-16, Mode 0, Mode 1 and Mode 2. Mode 1 is intended to support full power transmission for non-coherent and partially coherent UEs with PA ‘Capability 2’ and ‘Capability 3’. In Mode 1, the power scaling scheme is unchanged (i.e., the same power scaling as specified in Rel-15 is used), and full power transmission is instead achieved by adding fully coherent precoders (for respective rank) to the non-coherent and partially coherent codebooks. Since the Rel-15 power scaling factor (ρ/ρ0) for fully coherent precoders is unity (=1), the UE will transmit these precoders with full output power.

An example of a 2 Tx non-coherent Mode 1 UE is shown in FIG. 2. Since here the UE transmits with rank 1 precoder [1 1], it will transmit on both of its Tx chains, and both are half power, the UE transmits the full 23 dBm.

The following fully coherent TPMIs have been added to the Rel-15 codebooks for Mode 1 operation. Note that in the 4 Tx case, since UEs capable of partially coherent operation can support non-coherent operation, rank 2 TPMI Index 6 and rank 3 TPMI Index 1 for non-coherent operation can be used by partially coherent UEs. Therefore, it was not necessary to define rank 2 or 3 TPMIs specifically for partially coherent operation.

### 2 TX Non-Coherent UEs:

| | Rank |
|---|---|
| | 1 |
| | TPMI Index |
| | 2 |
| TPMI | $\frac{1}{\sqrt{2}} [ \begin{matrix}1 \\ 1\end{matrix} ]$ |

### 4 TX Non-Coherent UEs:

| | Rank | | |
|---|---|---|---|
| | 1 | 2 | 3 |
| | TPMI Index | | |
| | 13 | 6 | 1 |
| TPMI | $\frac{1}{2} [ \begin{matrix}1 \\ 1 \\ j \\ j\end{matrix} ]$ | $\frac{1}{2} [ \begin{matrix}1 & 0 \\ 0 & 1 \\ 1 & 0 \\ 0 & - j\end{matrix} ]$ | $\frac{1}{2} [ \begin{matrix}1 & 0 & 0 \\ 0 & 1 & 0 \\ 0 & 0 & 1 \\ 0 & 0 & 0\end{matrix} ]$ |

### 4 TX Partially Coherent UEs: Rank 1:

| | Rank | | | | | | | |
|---|---|---|---|---|---|---|---|---|
| | CP-OFDM | | | | DFT-S-OFDM | | | |
| | TPMI Index | | | | | | | |
| | 12 | 13 | 14 | 15 | 12 | 13 | 14 | 15 |
| TPMI | $\frac{1}{2} [ \begin{matrix}1 \\ 1 \\ 1 \\ 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ - 1\end{matrix} ]$ | $\frac{1}{2} [ \begin{matrix}1 \\ 1 \\ - j \\ - j\end{matrix} ]$ | $\frac{1}{2} [ \begin{matrix}1 \\ 1 \\ 1 \\ - 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ 1\end{matrix} ]$ | $\frac{1}{2} [ \begin{matrix}1 \\ 1 \\ - j \\ - j\end{matrix} ]$ |

### Agreements in Rel-18 Related to 8 Tx UE

In NR Rel-18, support for 8 TX UEs will be specified. As part of this it has been agreed that two types of partially coherent UEs will be supported, one with 2 antenna groups (with 4 antennas per antenna group), and one with four antenna groups (with two antennas per antenna group). It has also been agreed that the antennas within one antenna group are assumed to be mutually coherent, and antennas belonging to different antenna groups are assumed not to be mutually coherent. FIG. 3 illustrates an example of a UE with 4 antenna groups, and where each antenna group consists of two antenna elements with mutually orthogonal polarizations.

In the last 3GPP meeting (RAN1 #110bis) an agreement with three candidate ways of numbering the 8 antenna ports for codebook design of an 8TX partial-coherent UE, configured with an 8-port SRS resource, for both 2 antenna groups and 4 antenna groups was made (where one alternative will be agreed for 2 antenna groups and one alternative will be agreed for 4 antenna groups during next 3GPP meeting):

### Agreement

For codebook design of an 8TX partial-coherent UE, configured with an 8-port SRS resource
For when Ng=2, down-select of the following convention for assumption of port coherency scheme is used
   Alt 1: two coherent groups of {0,2,4,6} and {1,3,5,7}
   Alt 2: two coherent groups of {0,1,4,5} and {2,3,6,7}
   Alt 3: two coherent groups of {0,1,2,3} and {4,5,6,7}
For when Ng=4, down-select of the following convention for assumption of port coherency scheme is used
   Alt 1: four coherent groups of {0,4}, {1,5}, {2,6}, and {3,7}
   Alt 2: four coherent groups of {0,1}, {2,3}, {4,5}, and {6,7}
   Alt3: four coherent groups of {0, 2}, {4, 6}, {1, 3} and {5, 7}
Note: Other alternatives which are not foreseen are not precluded
   These different alternatives will correspond to the antenna port numbering, as illustrated in FIG. 4.

There currently exist certain challenge(s). Mode 1 Rel 16 full power mode was introduced for a partially and non-coherent UE in Rel-16 for up to 4 TX chains by introducing a set of precoders which the UE should apply full output power with. In some cases, an antenna port has a resource grid that is mapped directly to a corresponding physical antenna port. In some cases, if two antenna ports are mapped to the same physical antenna port, their resource grids are summed up. In some cases, antenna ports are mapped directly to physical antenna ports. In other cases, it is possible to have two or more antenna ports mapped to one physical antenna port. However, how to design the set of full power precoders for a partially coherent 8 TX UE with two or four antenna groups is an open issue (antenna groups are a new thing introduced in Rel-18 where the antennas within one antenna port group are assumed to be calibrated/coherent and consist of one or more dual-polarized antenna elements).

### Summary

Systems and methods for full power transmission for a partially coherent Tx User Equipment (UE) are provided. In some embodiments, the UE receives a configuration that indicates a full power mode of operation; transmits reference signals from each antenna port group of two or more antenna port groups; receives an indication to use a precoder for the full power mode transmission where the indicated precoder indicates a polarization and a spatial direction for each of the two or more antenna port groups; and transmits a single layer using the indicated precoder on the two or more antenna port groups.

In some embodiments, the indication to use a precoder comprises a Precoder Matrix Indicators (PMI) or a TPMI. In some embodiments, the reference signals comprise SRS. In some embodiments, the UE is configured with a partially coherent codebook with two or four antenna groups. In some embodiments, the UE comprises eight Tx partially coherent antennas.

In some embodiments, the precoder is from a set of precoders that take the spatial direction and polarization properties of the channel into account. In some embodiments, the precoder is from one of different TPMIs/PMIs for the full power mode of operation are used for a partially coherent UE with four antenna groups and partially coherent UE with two antenna groups. In some embodiments, a single precoder matrix is applied over all eight antenna ports. In some embodiments, the precoder is from one of different TPMIs/PMIs where the different TPMIs/PMIs have different co-phasing factors between the four antenna ports belonging to the same antenna group.

In some embodiments, the precoder is from one of different TPMIs/PMIs, and where for each TPMI/PMI the polarization is the same for all antenna port groups, but for different TPMIs/PMIs, the polarization is different. In some embodiments, the precoder is from one of different TPMIs/PMIs, and where for each TPMI/PMI the spatial direction is the same for all antenna port groups, but for different TPMIs/PMIs, the spatial direction is different. In some embodiments, the precoder results in the same spatial direction for all antenna port groups, but for different antenna port groups the polarization is different.

In some embodiments, the precoder results in the same polarization for all antenna port groups, but for different antenna port groups the spatial direction is different.

In some embodiments, the precoder results in different polarizations and different spatial directions for different antenna port groups.

In some embodiments, the precoder is an 8-port TPMI/PMI that is divided into two 4-port TPMIs/PMIs. In some embodiments, two separate fields in DCI are used to indicate TPMIs/PMIs, where a first field is used to indicate TPMI/PMI for a first antenna group and a second field is used to indicate TPMI/PMI for a second antenna group.

In some embodiments, the UE is equipped with 2 antenna groups, with 4 antennas in each group, and two “four-port TPMIs”, one per antenna group, are used to indicate a precoding matrix index and rank per antenna group.

In some embodiments, the method also includes: receiving a DCI triggering a transmission; where the DCI comprises a new single-bit bitfield is added in DCI, where the single-bit bitfield is used to indicate that single layer transmission should be applied over the two antenna groups. In some embodiments, this field is only present in DCI when a UE is configured with the full power mode of operation.

Some embodiments describe a set of precoders that can be used for full output power when the UE has been configured with the corresponding full power mode and a partially coherent codebook with 2 or 4 antenna groups.

Certain embodiments may provide one or more of the following technical advantages. The proposed solution enables full output power to be transmitted in UL for a set of precoders for an 8 Tx partially coherent UE with 2 or 4 antenna group, where the precoders take the spatial and polarization properties of the channel into account, which could improve the coverage and performance in UL.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 schematically illustrates three different UE PA architectures;

FIG. 2 illustrates the use of CDD with the delay unit Z^{-N};

FIG. 3 illustrates an example of a UE with four antenna groups, and where each antenna group consists of two antenna elements with mutually orthogonal polarizations;

FIG. 4 illustrates different alternatives corresponding to antenna port numbering;

FIG. 5A illustrates a method of operating a UE as described herein;

FIG. 5B illustrates a method of operating a network node as described herein;

FIG. 6 shows an example of a communication system in accordance with some embodiments;

FIG. 7 shows a UE in accordance with some embodiments;

FIG. 8 shows a network node in accordance with some embodiments;

FIG. 9 is a block diagram of a host, which may be an embodiment of the host of FIG. 6, in accordance with various aspects described herein;

FIG. 10 is a block diagram illustrating a virtualization environment in which functions implemented by some embodiments may be virtualized; and

FIG. 11 shows a communication diagram of a host communicating via a network node with a UE over a partially wireless connection in accordance with some embodiments.

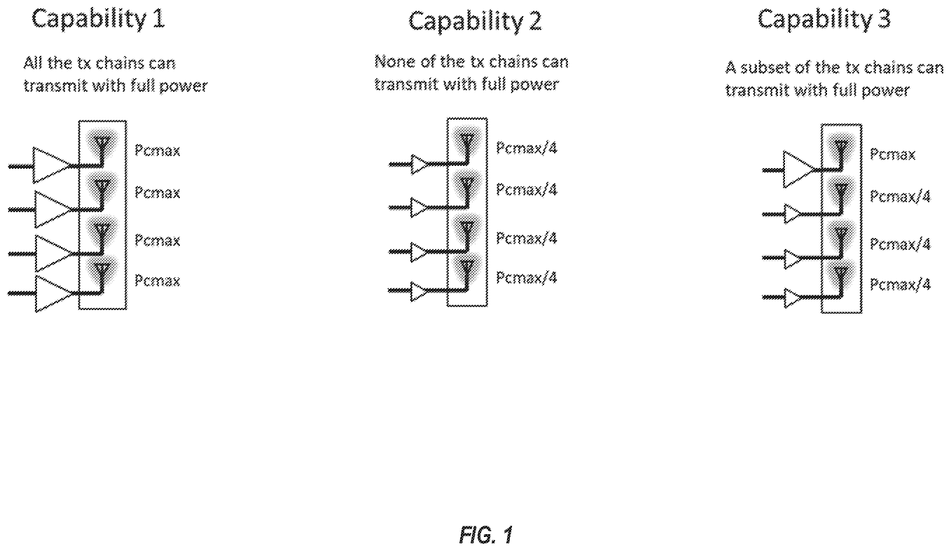

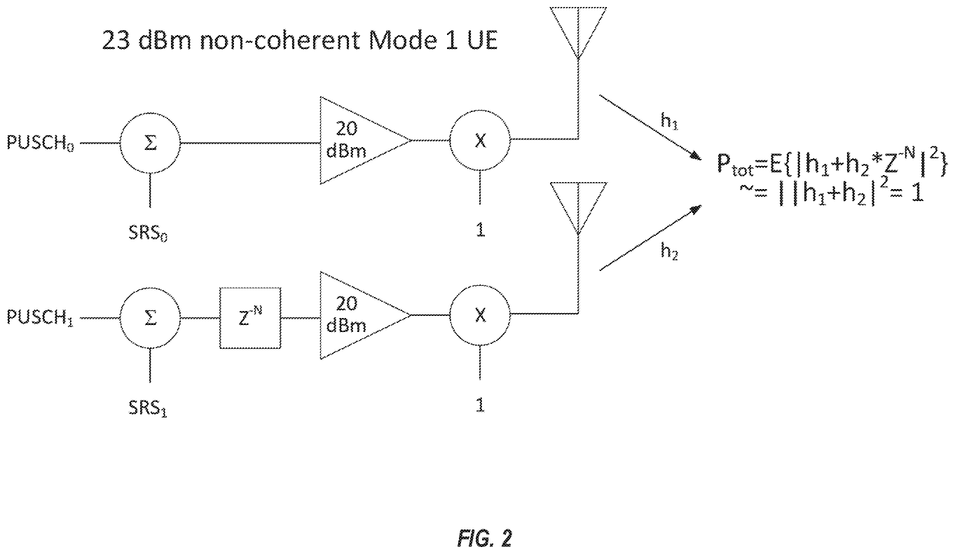

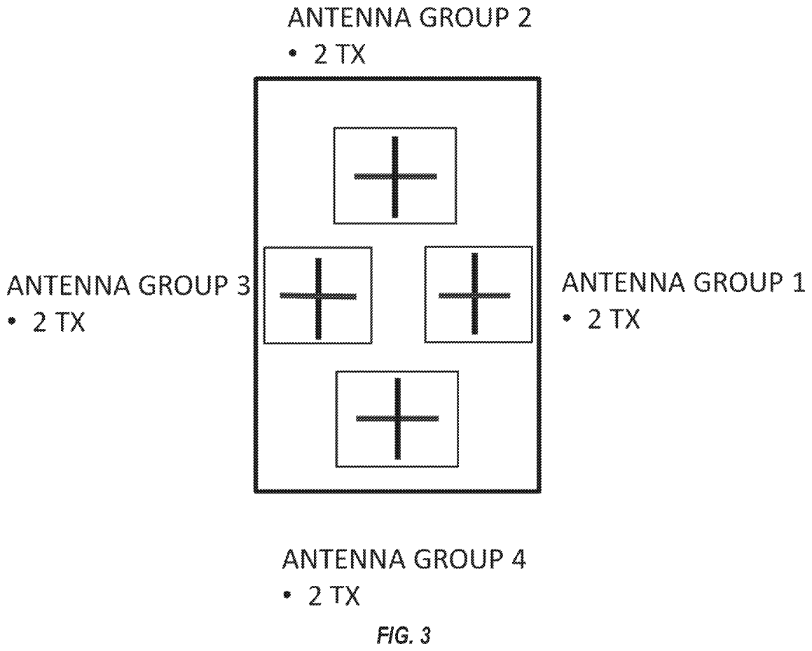

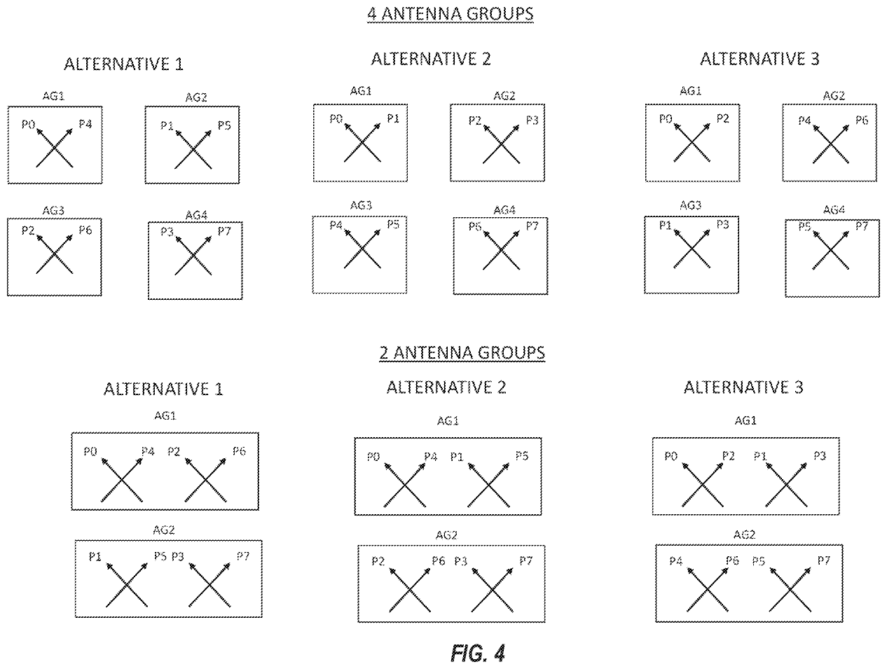

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

As used herein, the abbreviation Transmit Precoder Matrix Indication (TPMI) to indicate when a codepoint of a bitfield (typically in DCI) indicates both a precoder matrix index and a rank (i.e., number of PUSCH layers), while the abbreviation Precoder Matrix Indicator (PMI) is used to only indicate a precoder matrix index.

It has not been decided in NR how the precoder and rank will be indicated to the UE for 8 Tx codebook-based UL transmission in Rel-18. There are mainly four options that could be specified:
One TPMI per antenna group
One PMI per antenna group and separate rank indication
One TPMI across all antenna groups
One PMI across all antenna groups and separate rank indication
   In the disclosure, different embodiments will be described for the different ways of indicating the precoder and rank.

### UE Capability Signaling

In the embodiments below, the UE is assumed to be configured with 8 antenna ports. However, the embodiments herein are not limited to 8 antenna ports.

In one embodiment a UE signals support “Rel-18 power mode 1” (or more generally, a full power mode of operation), which means that the UE supports one or more embodiment described in this disclosure. In one embodiment, the UE explicitly signals support for one, a subset or all of the full power TPMIs/PMIs associated with the “Rel-18 power mode 1”. In one embodiment, UE explicitly signals support for one, a subset, or all of the ranks that the UE supports full power for associated with the “Rel-18 power mode 1”. In one embodiment, different TPMIs/PMIs for full power mode 1 in Rel-18 is used for a partially coherent UE with 4 antenna groups and partially coherent UE with 2 antenna groups. In one embodiment, the UE signals in UE capability if it supports full power mode 1 for one or more of;
both 4 antenna groups & 2 antenna groups
only for 2 antenna groups
only 4 antenna groups.

### Embodiments Related to TPMI/PMIs for Full Output Power for 8 Tx UE with 2 Antenna Port Groups

In these embodiments it is assumed that a single precoder matrix is applied over all 8 Tx ports (with or without a joint rank indication).

In one embodiment, one or more of the TPMI/PMIs described in the lists below can be used by a UE for full power transmission for rank 1 when the UE has indicated in UE capability that it supports “Rel-18 power mode 1” or if the UE has indicated that is supports “Rel-18 power mode 1” for a partially coherent codebook designed for 2 antenna groups. Each TPMI/PMI is described according to the following order: [P0, P1, P2, P3, P4, P5, P6, P7].

Since the UE coherently can/will combine the transmission from four Tx antennas within the same antenna group, in one embodiment, several different TPMIs/PMIs are included where the different TPMIs/PMIs have different co-phasing factors between the four Tx antennas belonging to the same antenna group.

In one embodiment, multiple different TPMIs/PMIs are used where the different TPMIs/PMIs results in different polarizations of the two antenna groups. For example, assuming that the antennas within each antenna group are calibrated to have the same phase (even though the phase between different antenna groups is unknown/random), the TPMI/PMI 1 and 2 in the lists below, will result in different polarizations (the first TPMI/PMI will result in vertical polarization over the two antenna groups while the second TPMI/PMI will result in horizontal polarization over the two antenna groups). One benefit with having these two options is that the polarization of the transmitted signal can be adapted to the channel (note that it is possible to add additional rows where all the −1 in the second TPMI/PMI are changed to j or −j to get even more polarization states to change between).

In one embodiment, multiple different TPMIs/PMIs are used where the different TPMIs/PMIs result in different polarizations for the two different antenna groups. This could be beneficial, in order to attain polarization diversity for the rank 1 transmission, where the polarization of the first antenna group is different from the polarization of the second antenna group. Another benefit of this solution is that the risk of destructively combining the received signal from both antenna groups is reduced. Two examples of these TPMIs/PMIs can be seen in index 3 and 4 in the lists below, where the third TPMI/PMI e.g., will result in vertical polarization for antenna group 1 and horizontal polarization for antenna group 2, while the fourth TPMI/PMI will result in horizontal polarization for antenna group 1 and vertical polarization for antenna group 2). Note that it is possible to add additional rows where all the −1 in TPMI/PMI 3 and 4 are changed to j or −j to get even more polarization states to change between.

In one embodiment, multiple different TPMIs/PMIs are used where the different TPMIs/PMIs results in different pointing directions for each antenna group. This could be beneficial, in order to adapt the beam angle according to the spatial properties of the channel. One example is illustrated in TPMI/PMI 5 below, where the pointing direction of the beam is the same for both antenna groups, but they are pointing in a different direction compared to TPMI/PMI 1. Note that it is possible to add additional rows where all the −1 in TPMI/PMI 5 are changed to j or −j to get even more spatial directions to change between.

In one embodiment, multiple different TPMIs/PMIs are used where the different TPMIs/PMIs results in different pointing directions for the beams for the two different antenna groups. This could be beneficial in case the two antenna groups are pointing in the same direction to attain spatial diversity of the first antenna group and the second antenna group. Another benefit of this solution is that the risk of destructively combining the received signal from both antenna groups is reduced. One example is illustrated in TPMI/PMI 6 below, where the pointing direction of the beam is different for antenna group 1 and antenna group 2. Note that it is possible to add additional rows where all the −1 in TPMI/PMI 6 are changed to j or −j to get even more spatial directions to change between.

In one embodiment, multiple different TPMIs/PMIs are used where the different TPMIs/PMIs results in different pointing and polarizations for the two different antenna groups. This could be beneficial in case the two antenna groups are pointing in the same direction to attain spatial diversity of the first antenna group and the second antenna group as well as polarization diversity. Another benefit of this solution is that the risk of destructively combining the received signal from both antenna groups is reduced. One example is illustrated in TPMI/PMI 7 below, where both the pointing direction and the polarization of the beam is different for antenna group 1 and antenna group 2. Note that it is possible to add additional rows where all the −1 in TPMI/PMI 6 are changed to j or −j to get even more spatial directions to change between.

These different TPMIs/PMIs are shown in the lists below. These lists create the same result, but are based on alternative port numbering for the antenna port groups. Other port numberings could be possible with the appropriate alteration of the list.

In case Alt 1 is agreed, with the port numbering {0, 2, 4, 6} and {1, 3, 5, 7}, the rank 1 TPMIs/PMIs will be:

$$1. [ 1 , 1 , 1 , 1 , 1 , 1 , 1 , 1 ]$$

$$2. [ 1 , 1 , 1 , 1 , - 1 , - 1 , - 1 , - 1 ]$$

$$3. [ 1 , 1 , 1 , 1 , 1 , - 1 , 1 , - 1 ]$$

$$4. [ 1 , 1 , 1 , 1 , - 1 , 1 , - 1 , 1 ]$$

$$5. [ 1 , 1 , - 1 , - 1 , 1 , 1 , - 1 , - 1 ]$$

$$6. [ 1 , 1 , 1 , - 1 , 1 , 1 , 1 , - 1 ]$$

$$7. [ 1 , 1 , 1 , - 1 , 1 , - 1 , 1 , 1 ]$$

In case Alt 2 is agreed, with the port numbering {0,1,4,5} and {2,3,6,7}, the rank 1 TPMIs/PMIs will be:

$$1. [ 1 , 1 , 1 , 1 , 1 , 1 , 1 , 1 ]$$

$$2. [ 1 , 1 , 1 , 1 , - 1 , - 1 , - 1 , - 1 ]$$

$$3. [ 1 , 1 , 1 , 1 , 1 , 1 , - 1 , - 1 ]$$

$$4. [ 1 , 1 , 1 , 1 , - 1 , - 1 , 1 , 1 ]$$

$$5. [ 1 , - 1 , 1 , - 1 , 1 , - 1 , 1 , - 1 ]$$

$$6. [ 1 , 1 , 1 , - 1 , 1 , 1 , 1 , - 1 ]$$

$$7. [ 1 , 1 , 1 , 1 , 1 , 1 , - 1 , - 1 ]$$

In case Alt 3 is agreed, with port numbering {0,1,2,3} and {4,5,6,7}, the rank 1 TPMI/PMIS will be

$$1. [ 1 , 1 , 1 , 1 , 1 , 1 , 1 , 1 ]$$

$$2. [ 1 , 1 , - 1 , - 1 , 1 , 1 , - 1 , - 1 ]$$

$$3. [ 1 , 1 , 1 , 1 , 1 , 1 , - 1 , - 1 ]$$

$$4. [ 1 , 1 , - 1 , - 1 , 1 , 1 , 1 , 1 ]$$

$$5. [ 1 , - 1 , 1 , - 1 , 1 , - 1 , 1 , - 1 ]$$

$$6. [ 1 , 1 , 1 , 1 , 1 , - 1 , 1 , - 1 ]$$

$$7. [ 1 , 1 , 1 , 1 , 1 , 1 , - 1 , - 1 ]$$

In one embodiment, the 8-port TPMIs/PMIs described in above embodiments are instead divided into two 4-port TPMIs/PMIs (i.e., two separate fields in DCI are used to indicate TPMI/PMI, where a first field is used to indicate TPMI/PMI for a first antenna group and a second field is used to indicate TPMI/PMI for a second antenna group). In one embodiment, the UE transmits with full power for a single UL layer, when certain dedicated full power mode PMIs/TPMIs are indicated for both antenna groups. For example, one or more dedicated TPMIs/PMIs are only used for full power mode 1 transmission, and when the gNB indicates such TPMIs/PMIs for both antenna groups, the UE applies rank 1 full power transmission over both antenna groups. One example of such TPMI/PMIs can be a precoder: [1,1,1,1,]. In one embodiment, similar dedicated full power TPMIs/PMIs are made for other ranks than rank 1 as well, and when these TPMI/PMIs are indicated to both antenna groups, the UE will transmit with full power for the associated rank.

### Embodiments Related to TPMI/PMIs for Full Output Power for 8 Tx UE with 4 Antenna Port Groups

In these embodiments it is assumed that a single precoder matrix is applied over all 8 Tx ports (with or without a joint rank indication).

In one embodiment, one or more of the TPMI/PMIs described below for Rank1, Rank 2 and Rank 3 can be used by a UE for full power transmission when the UE has indicated in UE capability that it supports “Rel-18 power mode 1” or if the UE has indicated that is supports “Rel-18 power mode 1” for a partially coherent codebook designed for 4 antenna groups. Each TPMI/PMI is described according to the following order: [P0, P1, P2, P3, P4, P5, P6, P7].

For Rank1, in one embodiment, one or more of the following TPMIs/PMIs can be included in the 8 Tx partially coherent codebook and can be used to indicate full power transmission for single layer PUSCH (see rank 1 list of TPMIs/PMIs below). Since the UE coherently can/will combine the transmission from two Tx antennas within the same antenna group, in one embodiment, several different TPMIs/PMIs are included where the different TPMIs/PMIs have different co-phasing factors between the two Tx antennas belonging to the same antenna group. The first 4 TPMIs/PMIs will apply the same precoding over each of the 4 antenna groups (which will result in the same polarization being transmitted from each antenna group considering the assumption made herein that odd-numbered ports are associated with a first polarization, and even-numbered ports are associated with a second polarization and that the antenna elements within one antenna port group are calibrated to have the same phase). However, in some cases, this might be un-desired, since it increases the risk that the received signals at the gNB from the multiple antenna groups are combined destructively, as well as it will increase the risk for polarization mismatch between the gNB and the UE. Hence, in one embodiment, some additional TPMIs/PMIs are included (rows 5-7) where the resulting polarization for the different antenna groups are mutually different from each other. These different TPMIs/PMIs are shown in the lists below. These lists create the same result, but are based on alternative port numbering for the antenna port groups. Other port numberings could be possible with the appropriate alteration of the list.
In case Alt 1 is agreed, with the port numbering {0,4}, {1,5}, {2,6}, and {3,7}, the rank 1 TPMIs/PMIs will be:

$$1. [ 1 , 1 , 1 , 1 , 1 , 1 , 1 , 1 ]$$

$$2. [ 1 , 1 , j , j , 1 , 1 , j , j ]$$

$$3. [ 1 , 1 , - 1 , - 1 , 1 , 1 , - 1 , - 1 ]$$

$$4. [ 1 , 1 , - j , - j , 1 , 1 , - j , - j ]$$

$$5. [ 1 , 1 , 1 , - 1 , 1 , 1 , j , - j ]$$

$$6. [ 1 , 1 , 1 , 1 , 1 , 1 , - 1 , - 1 ]$$

$$7. [ 1 , 1 , 1 , 1 , 1 , 1 , - j , - j ]$$

In case Alt 2 is agreed, with the port numbering {0,1}, {2,3}, {4,5}, and {6,7}, the rank 1 TPMIs/PMIs will instead be:

$$1. [ 1 , 1 , 1 , 1 , 1 , 1 , 1 , 1 ]$$

$$2. [ 1 , j , 1 , j , 1 , j , 1 , j ]$$

$$3. [ 1 , - 1 , 1 , - 1 , 1 , - 1 , 1 , - 1 ]$$

$$4. [ 1 , - j , 1 , - j , 1 , - j , 1 , - j ]$$

$$5. [ 1 , 1 , 1 , j , 1 , - 1 , 1 , - j ]$$

$$6. [ 1 , 1 , 1 , - 1 , 1 , 1 , 1 , - 1 ]$$

$$7. [ 1 , 1 , 1 , - j , 1 , 1 , 1 , - j ]$$

In case Alt 3 is agreed, with the port numbering {0, 2}, {4, 6}, {1, 3} and {5, 7}, the TPMIs/PMIs will be:

$$1. [ 1 , 1 , 1 , 1 , 1 , 1 , 1 , 1 ]$$

$$2. [ 1 , 1 , 1 , 1 , j , j , j , j ]$$

$$3. [ 1 , 1 , 1 , 1 , - 1 , - 1 , - 1 , - 1 ]$$

$$4. [ 1 , 1 , 1 , 1 , - j , - j , - j , - j ]$$

$$5. [ 1 , 1 , 1 , j , 1 , 1 , - 1 , - j ]$$

$$6. [ 1 , 1 , 1 , - 1 , 1 , 1 , 1 , - 1 ]$$

$$7. [ 1 , 1 , 1 , - j , 1 , 1 , 1 , - j ]$$

In one embodiment, in addition to having full power transmission over all the 4 antenna groups, half power transmission is performed over two of the antenna groups. This could be solved by for example having following precoders, and where the UE transmits with half total output power for rank 1 over the first and the second antenna group (other similar TPMIs/PMIs can easily be generated for other combination of antenna groups):
In case Alt 1 is agreed, with the port numbering {0,4}, {1,5}, {2,6}, and {3,7}, the rank 1 TPMIs/PMIs will be:

$$1. [ 1 , 1 , 0 , 0 , 1 , 1 , 0 , 0 ]$$

In case Alt 2 is agreed, with the port numbering {0,1}, {2,3}, {4,5}, and {6,7}, the rank 1 TPMIs/PMIs will be:

$$1. [ 1 , 1 , 1 , 1 , 0 , 0 , 0 , 0 ]$$

In case Alt 3 is agreed, with the port numbering {0, 2}, {4, 6}, {1, 3} and {5, 7}, the rank 1 TPMIs/PMIs will be:

$$1. [ 1 , 0 , 1 , 0 , 1 , 0 , 1 , 0 ]$$

For Rank2, in one embodiment, one or more of the following TPMIs/PMIs can be included in the 8 Tx partially coherent codebook and can be used to indicate full power transmission for two-layer PUSCH. Since the UE coherently can combine the transmission from two Tx antennas within the same antenna group, in one embodiment, several different TPMIs/PMIs are included where the different TPMIs/PMIs have different co-phasing factors between the two Tx antennas belonging to the same antenna group. The first 4 TPMIs/PMIs will apply the same precoding over the 4 antenna groups, which might result in the signal transmitted from all the antenna groups have the same polarization. However, in some cases, this might be un-desired, since it increases the risk that the received signals at the gNB from the multiple antenna groups are combined destructively, and it will increase the risk for polarization mismatch between the gNB and the UE. Hence, in one embodiment, some additional TPMIs/PMIs are included (row 5-7) where the resulting polarization for the different antenna groups are mutual different from each other.
Rank 2 TPMIs/PMIs for Alt 2 with the port numbering {0,1}, {2,3}, {4,5}, and {6,7}:

$$1. [ 1 , 1 , 1 , 1 , 0 , 0 , 0 , 0 ; 0 , 0 , 0 , 0 , 1 , 1 , 1 , 1 ]$$

$$2. [ 1 , j , 1 , j , 0 , 0 , 0 , 0 ; 0 , 0 , 0 , 0 , 1 , j , 1 , j ]$$

$$3. [ 1 , - 1 , 1 , - 1 , 0 , 0 , 0 , 0 ; 0 , 0 , 0 , 0 , 1 , - 1 , 1 , - 1 ]$$

$$4. [ 1 , - j , 1 , - j , 0 , 0 , 0 , 0 ; 0 , 0 , 0 , 0 , 1 , - j , 1 , - j ]$$

$$5. [ 1 , 1 , 1 , - 1 , 0 , 0 , 0 , 0 ; 0 , 0 , 0 , 0 , 1 , 1 , 1 , - 1 ]$$

$$6. [ 1 , 1 , 1 , - 1 , 0 , 0 , 0 , 0 ; 0 , 0 , 0 , 0 , 1 , 1 , 1 , - 1 ]$$

$$7. [ 1 , 1 , 1 , j , 0 , 0 , 0 , 0 ; 0 , 0 , 0 , 0 , 1 , 1 , 1 , j ]$$

Similar column permutations as described for rank 1 can be made for rank 2 to support Alt 1 with the port numbering {0,4}, {1,5}, {2,6}, and {3,7}, or Alt 3 with the port numbering {0, 2}, {4, 6}, {1, 3} and {5, 7}.

For Rank3, in one embodiment, one or more of the following TPMIs/PMIs can be included in the 8 Tx partially coherent codebook and can be used to indicate full power transmission for three-layer PUSCH. Since the UE coherently can/will combine the transmission from two Tx antennas within the same antenna group, in one embodiment, several different TPMIs/PMIs are included where the different TPMIs/PMIs have different co-phasing factors between the two Tx antennas belonging to the same antenna group. For the first subset of TPMIs/PMIs for rank3, each TPMI/PMI utilizes all 8 TX chains. This might be required for example if one or more Tx chains has a PA that only can transmit with Pmax-9 dB (for example 14 dBm for a UE with maximum output power of 23 dBm). For the second subset of PMIs for rank3, each TPMI/PMI utilizes only 6 out of 8 TX chains. This can be useful for example if at least 6 Tx chains has PAs that support output powers larger then Pmax-6 dB (for example that 6 out of 8 PAs support an output power of 17 dBm or more for a UE with maximum output power of 23 dBm). In one embodiment, additional TPMIs/PMIs are included where the resulting polarization for the different antenna groups are mutual different from each other, in order to improve polarization diversity, and reduce the risk that the received signals at the gNB from the multiple antenna groups are combined destructively.
First subset of rank 3 TPMIs/PMIs for Alt 2 with the port numbering {0,1}, {2,3}, {4,5}, and {6,7}:

$$[ 1 , 1 , 1 , 1 , 0 , 0 , 0 , 0 ; 0 , 0 , 0 , 0 , 1 , 1 , 0 , 0 ; 0 , 0 , 0 , 0 , 0 , 0 , 1 , 1 ]$$

$$[ 1 , j , 1 , j , 0 , 0 , 0 , 0 ; 0 , 0 , 0 , 0 , 1 , j , 0 , 0 ; 0 , 0 , 0 , 0 , 0 , 0 , 1 , j ]$$

$$[ 1 , - 1 , 1 , - 1 , 0 , 0 , 0 , 0 ; 0 , 0 , 0 , 0 , 1 , - 1 , 0 , 0 ; 0 , 0 , 0 , 0 , 0 , 0 , 1 , - 1 ]$$

$$[ 1 , - j , 1 , - j , 0 , 0 , 0 , 0 ; 0 , 0 , 0 , 0 , 1 , - j , 0 , 0 ; 0 , 0 , 0 , 0 , 0 , 0 , 1 , - j ]$$

Second subset of rank 3 TPMIs/PMIs for Alt 2 with the port numbering {0,1}, {2,3}, {4,5}, and {6,7}:

$$[ 1 , 1 , 0 , 0 , 0 , 0 , 0 , 0 ; 0 , 0 , 1 , 1 , 0 , 0 , 0 , 0 ; 0 , 0 , 0 , 0 , 1 , 1 , 0 , 0 ]$$

$$[ 1 , j , 0 , 0 , 0 , 0 , 0 , 0 ; 0 , 0 , 1 , j , 0 , 0 , 0 , 0 ; 0 , 0 , 0 , 0 , 1 , j , 0 , 0 ]$$

$$[ 1 , - 1 , 0 , 0 , 0 , 0 , 0 , 0 ; 0 , 0 , 1 , - 1 , 0 , 0 , 0 , 0 ; 0 , 0 , 0 , 0 , 1 , - 1 , 0 , 0 ; ]$$

$$[ 1 , 1 , 0 , 0 , 0 , 0 , 0 , 0 ; 0 , 0 , 1 , 1 , 0 , 0 , 0 , 0 ; 0 , 0 , 0 , 0 , 1 , 1 , 0 , 0 ]$$

Similar column permutations as described for rank 1 can be made for rank 3 to support Alt 1 with the port numbering {0,4}, {1,5}, {2,6}, and {3,7}, or Alt 3 with the port numbering {0, 2}, {4, 6}, {1, 3} and {5, 7}.

### Embodiments Related to Separate TPMIs/PMIs for Different Antenna Groups for Full Output Power for 8 Tx UE

In these embodiments it is assumed that a separate TPMI/PMI is applied for different antenna groups for an 8 Tx UE (with or without a joint rank indication).

In one example, a UE is equipped with 2 antenna groups, with 4 antennas in each group, and two “four-port TPMIs”, one per antenna group, are used to indicate the precoding matrix index and rank per antenna group (the total number of layers for the PUSCH will then be the sum of the number of layers indicated in the first “four-port TPMI” and the second “four-port TPMI”). In this case, it is needed to explicitly indicate to the UE when it should transmit a single layer PUSCH over all 8 TX chains using full power transmission (since otherwise, transmitting PUSCH from both antenna groups would result in at least two layers in total, one per antenna group). In one embodiment, a new single-bit bitfield is added in DCI triggering the PUSCH transmission, where the single-bit bitfield is used to indicate that single layer transmission should be applied over the two antenna groups (to enable full power transmission). In one embodiment, this field is only present in DCI when a UE is configured with “Rel-18 power mode 1”.

In one embodiment, the number of layers is indicated separately compared to the precoder matrix index. For example, two “four-port PMI” fields are used to indicate the precoder matrix index per antenna group, and another field is used to indicate the number of PUSCH layers to be transmitted from respective antenna group. In one embodiment, a single bitfield is used to indicate the rank for each of the two antenna groups (for example one codepoint is indicating rank 1 for the first antenna group and rank 2 for the second antenna group, where a 10 second codepoint indicates rank 1 for the first antenna group and rank 3 for the second antenna group, and so on). And in one related embodiment, one codepoint of this bitfield is used to indicate that a single-layer PUSCH should be transmitted over both antenna groups. In one related embodiment, the UE applied full power transmission when indicated with that codepoint. In one embodiment, the codepoint supporting full power transmission is removed when the UE is not configured with “Rel-18 power mode 1”.

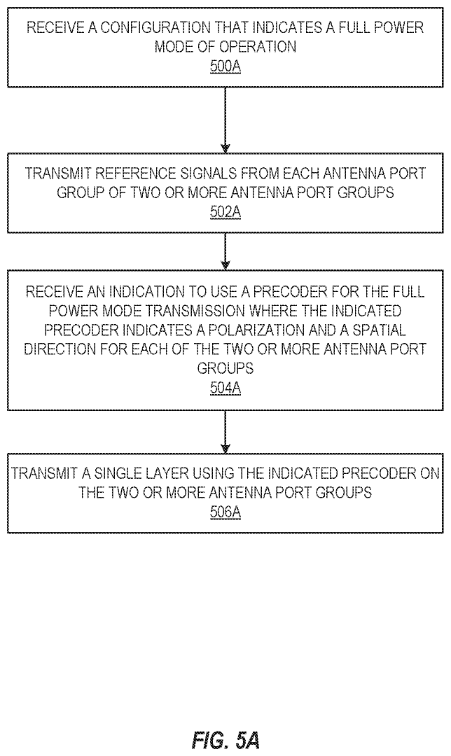

FIG. 5A illustrates a method of operating a UE as described herein. In some embodiments, the UE receives (step 500A) a configuration that indicates a full power mode of operation; transmits (step 502A) reference signals from each antenna port group of two or more antenna port groups; receives (step 504A) an indication to use a precoder for the full power mode transmission where the indicated precoder indicates a polarization and a spatial direction for each of the two or more antenna port groups; and transmits (step 506A) a single layer using the indicated precoder on the two or more antenna port groups. In this way, the proposed solution enables full output power to be transmitted in UL for a set of precoders for an 8 Tx partially coherent UE with 2 or 4 antenna group, where the precoders take the spatial and polarization properties of the channel into account, which could improve the coverage and performance in UL. In some embodiments, this is accomplished by using a set of precoders that can be used for full output power when the UE is configured with full power mode and partially coherent codebook with either 2 or 4 antenna groups. In some embodiments (e.g., 8 Tx antennas), there are two specific UE antenna architectures assumed. One architecture is for 4 antenna-port groups and one architecture is for 2 antenna-port groups. For 2 antenna-port groups, a uniform linear array with two dual polarized antenna elements is assumed. Using one of these assumptions can allow the network node and/or the UE to choose a precoder that takes advantage of the assumed architecture.

FIG. 5B illustrates a method of operating a network node as described herein. In some embodiments, the network node transmits (step 500B), to a UE, a configuration that indicates a full power mode of operation; receives (step 502B), from the UE, reference signals from each antenna port group of two or more antenna port groups; transmits (step 504B), to the UE, an indication to use a precoder for the full power mode transmission where the indicated precoder indicates a polarization and a spatial direction for each of the two or more antenna port groups; and receives (step 506B), from the UE, a single layer using the indicated precoder on the two or more antenna port groups. In this way, the proposed solution enables full output power to be transmitted in UL for a set of precoders for an 8 Tx partially coherent UE with 2 or 4 antenna group, where the precoders take the spatial and polarization properties of the channel into account, which could improve the coverage and performance in UL. In some embodiments, one reference signal (e.g., SRS) is transmitted per antenna per antenna port group.

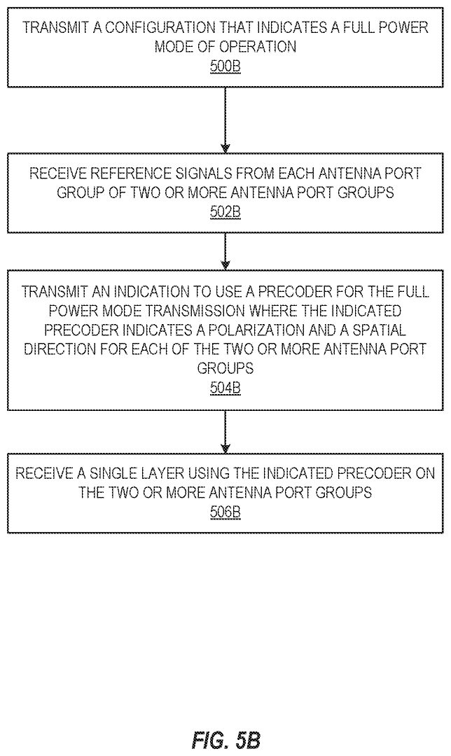

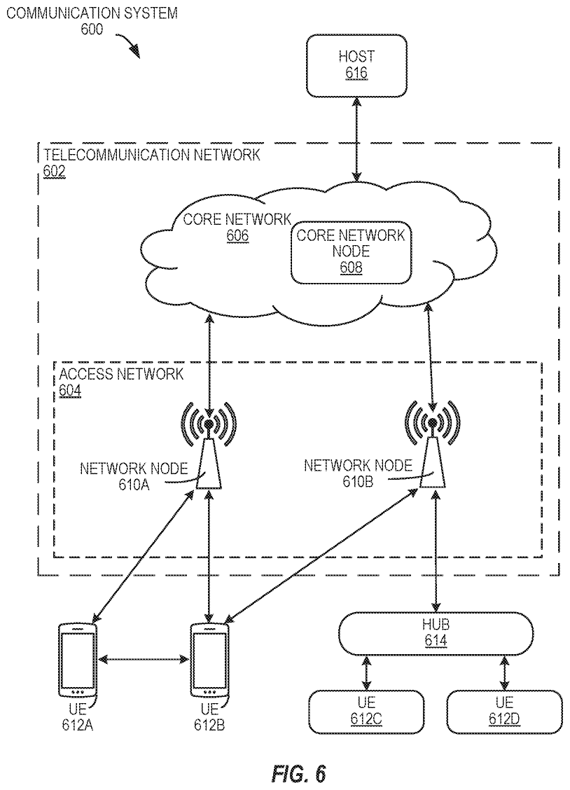

FIG. 6 shows an example of a communication system 600 in accordance with some embodiments. In the example, the communication system 600 includes a telecommunication network 602 that includes an access network 604, such as a Radio Access Network (RAN), and a core network 606, which includes one or more core network nodes 608. The access network 604 includes one or more access network nodes, such as network nodes 610A and 610B (one or more of which may be generally referred to as network nodes 610), or any other similar Third Generation Partnership Project (3GPP) access node or non-3GPP Access Point (AP). The network nodes 610 facilitate direct or indirect connection of User Equipment (UE), such as by connecting UEs 612A, 612B, 612C, and 612D (one or more of which may be generally referred to as UEs 612) to the core network 606 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 600 may include any number of wired or wireless networks, network nodes, UEs, and/or any other components or systems that may facilitate or participate in the communication of data and/or signals whether via wired or wireless connections. The communication system 600 may include and/or interface with any type of communication, telecommunication, data, cellular, radio network, and/or other similar type of system.

The UEs 612 may be any of a wide variety of communication devices, including wireless devices arranged, configured, and/or operable to communicate wirelessly with the network nodes 610 and other communication devices. Similarly, the network nodes 610 are arranged, capable, configured, and/or operable to communicate directly or indirectly with the UEs 612 and/or with other network nodes or equipment in the telecommunication network 602 to enable and/or provide network access, such as wireless network access, and/or to perform other functions, such as administration in the telecommunication network 602.

In the depicted example, the core network 606 connects the network nodes 610 to one or more hosts, such as host 616. These connections may be direct or indirect via one or more intermediary networks or devices. In other examples, network nodes may be directly coupled to hosts. The core network 606 includes one more core network nodes (e.g., core network node 608) that are structured with hardware and software components. Features of these components may be substantially similar to those described with respect to the UEs, network nodes, and/or hosts, such that the descriptions thereof are generally applicable to the corresponding components of the core network node 608. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 616 may be under the ownership or control of a service provider other than an operator or provider of the access network 604 and/or the telecommunication network 602 and may be operated by the service provider or on behalf of the service provider. The host 616 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 600 of FIG. 6 enables connectivity between the UEs, network nodes, and hosts. In that sense, the communication system 600 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 602 is a cellular network that implements 3GPP standardized features. Accordingly, the telecommunication network 602 may support network slicing to provide different logical networks to different devices that are connected to the telecommunication network 602. For example, the telecommunication network 602 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 612 are configured to transmit and/or receive information without direct human interaction. For instance, a UE may be designed to transmit information to the access network 604 on a predetermined schedule, when triggered by an internal or external event, or in response to requests from the access network 604. Additionally, a UE may be configured for operating in single- or multi-Radio Access Technology (RAT) or multi-standard mode. For example, a UE may operate with any one or combination of WiFi, New Radio (NR), and LTE, i.e., be configured for Multi-Radio Dual Connectivity (MR-DC), such as Evolved UMTS Terrestrial RAN (E-UTRAN) NR-Dual Connectivity (EN-DC).

In the example, a hub 614 communicates with the access network 604 to facilitate indirect communication between one or more UEs (e.g., UE 612C and/or 612D) and network nodes (e.g., network node 610B). In some examples, the hub 614 may be a controller, router, content source and analytics, or any of the other communication devices described herein regarding UEs. For example, the hub 614 may be a broadband router enabling access to the core network 606 for the UEs. As another example, the hub 614 may be a controller that sends commands or instructions to one or more actuators in the UEs. Commands or instructions may be received from the UEs, network nodes 610, or by executable code, script, process, or other instructions in the hub 614. As another example, the hub 614 may be a data collector that acts as temporary storage for UE data and, in some embodiments, may perform analysis or other processing of the data. As another example, the hub 614 may be a content source. For example, for a UE that is a Virtual Reality (VR) headset, display, loudspeaker or other media delivery device, the hub 614 may retrieve VR assets, video, audio, or other media or data related to sensory information via a network node, which the hub 614 then provides to the UE either directly, after performing local processing, and/or after adding additional local content. In still another example, the hub 614 acts as a proxy server or orchestrator for the UEs, in particular in if one or more of the UEs are low energy IoT devices.

The hub 614 may have a constant/persistent or intermittent connection to the network node 610B. The hub 614 may also allow for a different communication scheme and/or schedule between the hub 614 and UEs (e.g., UE 612C and/or 612D), and between the hub 614 and the core network 606. In other examples, the hub 614 is connected to the core network 606 and/or one or more UEs via a wired connection. Moreover, the hub 614 may be configured to connect to a Machine-to-Machine (M2M) service provider over the access network 604 and/or to another UE over a direct connection. In some scenarios, UEs may establish a wireless connection with the network nodes 610 while still connected via the hub 614 via a wired or wireless connection. In some embodiments, the hub 614 may be a dedicated hub—that is, a hub whose primary function is to route communications to/from the UEs from/to the network node 610B. In other embodiments, the hub 614 may be a non-dedicated hub—that is, a device which is capable of operating to route communications between the UEs and the network node 610B, but which is additionally capable of operating as a communication start and/or end point for certain data channels.

FIG. 7 shows a UE 700 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VoIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 700 includes processing circuitry 702 that is operatively coupled via a bus 704 to an input/output interface 706, a power source 708, memory 710, a communication interface 712, and/or any other component, or any combination thereof. Certain UEs may utilize all or a subset of the components shown in FIG. 7. The level of integration between the components may vary from one UE to another UE. Further, certain UEs may contain multiple instances of a component, such as multiple processors, memories, transceivers, transmitters, receivers, etc.

The processing circuitry 702 is configured to process instructions and data and may be configured to implement any sequential state machine operative to execute instructions stored as machine-readable computer programs in the memory 710. The processing circuitry 702 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 702 may include multiple Central Processing Units (CPUs). In some embodiments, the UE 700 includes processing circuitry 702 and memory 710. The memory 710 includes instructions to cause the UE 700 to perform any of the steps of FIG. 5A or any of the embodiments described herein.

In the example, the input/output interface 706 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 700. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 708 is structured as a battery or battery pack. Other types of power sources, such as an external power source (e.g., an electricity outlet), photovoltaic device, or power cell, may be used. The power source 708 may further include power circuitry for delivering power from the power source 708 itself, and/or an external power source, to the various parts of the UE 700 via input circuitry or an interface such as an electrical power cable. Delivering power may be, for example, for charging the power source 708. Power circuitry may perform any formatting, converting, or other modification to the power from the power source 708 to make the power suitable for the respective components of the UE 700 to which power is supplied.

The memory 710 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 710 includes one or more application programs 714, such as an operating system, web browser application, a widget, gadget engine, or other application, and corresponding data 716. The memory 710 may store, for use by the UE 700, any of a variety of various operating systems or combinations of operating systems.

The memory 710 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 710 may allow the UE 700 to access instructions, application programs, and the like stored on transitory or non-transitory memory media, to off-load data, or to upload data. An article of manufacture, such as one utilizing a communication system, may be tangibly embodied as or in the memory 710, which may be or comprise a device-readable storage medium.

The processing circuitry 702 may be configured to communicate with an access network or other network using the communication interface 712. The communication interface 712 may comprise one or more communication subsystems and may include or be communicatively coupled to an antenna 722. The communication interface 712 may include one or more transceivers used to communicate, such as by communicating with one or more remote transceivers of another device capable of wireless communication (e.g., another UE or a network node in an access network). Each transceiver may include a transmitter 718 and/or a receiver 720 appropriate to provide network communications (e.g., optical, electrical, frequency allocations, and so forth). Moreover, the transmitter 718 and receiver 720 may be coupled to one or more antennas (e.g., the antenna 722) and may share circuit components, software, or firmware, or alternatively be implemented separately.

In the illustrated embodiment, communication functions of the communication interface 712 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HIITP), and so forth.

Regardless of the type of sensor, a UE may provide an output of data captured by its sensors, through its communication interface 712, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected, an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 700 shown in FIG. 7.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

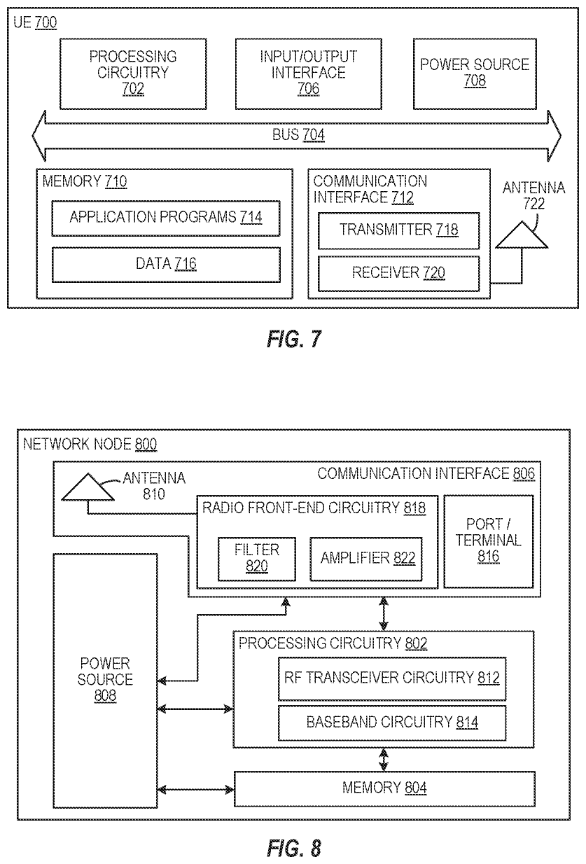

FIG. 8 shows a network node 800 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), and NR Node Bs (gNBs)).

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 800 includes processing circuitry 802, memory 804, a communication interface 806, and a power source 808. The network node 800 may be composed of multiple physically separate components (e.g., a Node B component and an RNC component, or a BTS component and a BSC component, etc.), which may each have their own respective components. In certain scenarios in which the network node 800 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 800 may be configured to support multiple RATs. In such embodiments, some components may be duplicated (e.g., separate memory 804 for different RATs) and some components may be reused (e.g., an antenna 810 may be shared by different RATs). The network node 800 may also include multiple sets of the various illustrated components for different wireless technologies integrated into network node 800, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 800.

The processing circuitry 802 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 800 components, such as the memory 804, to provide network node 800 functionality. In some embodiments, the network node 800 includes processing circuitry 802 and memory 804. The memory 804 includes instructions to cause the network node 800 to perform any of the steps of FIG. 5B or any of the embodiments described herein.

In some embodiments, the processing circuitry 802 includes a System on a Chip (SOC). In some embodiments, the processing circuitry 802 includes one or more of Radio Frequency (RF) transceiver circuitry 812 and baseband processing circuitry 814. In some embodiments, the RF transceiver circuitry 812 and the baseband processing circuitry 814 may be on separate chips (or sets of chips), boards, or units, such as radio units and digital units. In alternative embodiments, part or all of the RF transceiver circuitry 812 and the baseband processing circuitry 814 may be on the same chip or set of chips, boards, or units.

The memory 804 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 802. The memory 804 may store any suitable instructions, data, or information, including a computer program, software, an application including one or more of logic, rules, code, tables, and/or other instructions capable of being executed by the processing circuitry 802 and utilized by the network node 800. The memory 804 may be used to store any calculations made by the processing circuitry 802 and/or any data received via the communication interface 806. In some embodiments, the processing circuitry 802 and the memory 804 are integrated.

The communication interface 806 is used in wired or wireless communication of signaling and/or data between a network node, access network, and/or UE. As illustrated, the communication interface 806 comprises port(s)/terminal(s) 816 to send and receive data, for example to and from a network over a wired connection. The communication interface 806 also includes radio front-end circuitry 818 that may be coupled to, or in certain embodiments a part of, the antenna 810. The radio front-end circuitry 818 comprises filters 820 and amplifiers 822. The radio front-end circuitry 818 may be connected to the antenna 810 and the processing circuitry 802. The radio front-end circuitry 818 may be configured to condition signals communicated between the antenna 810 and the processing circuitry 802. The radio front-end circuitry 818 may receive digital data that is to be sent out to other network nodes or UEs via a wireless connection. The radio front-end circuitry 818 may convert the digital data into a radio signal having the appropriate channel and bandwidth parameters using a combination of the filters 820 and/or the amplifiers 822. The radio signal may then be transmitted via the antenna 810. Similarly, when receiving data, the antenna 810 may collect radio signals which are then converted into digital data by the radio front-end circuitry 818. The digital data may be passed to the processing circuitry 802. In other embodiments, the communication interface 806 may comprise different components and/or different combinations of components.

In certain alternative embodiments, the network node 800 does not include separate radio front-end circuitry 818; instead, the processing circuitry 802 includes radio front-end circuitry and is connected to the antenna 810. Similarly, in some embodiments, all or some of the RF transceiver circuitry 812 is part of the communication interface 806. In still other embodiments, the communication interface 806 includes the one or more ports or terminals 816, the radio front-end circuitry 818, and the RF transceiver circuitry 812 as part of a radio unit (not shown), and the communication interface 806 communicates with the baseband processing circuitry 814, which is part of a digital unit (not shown).

The antenna 810 may include one or more antennas, or antenna arrays, configured to send and/or receive wireless signals. The antenna 810 may be coupled to the radio front-end circuitry 818 and may be any type of antenna capable of transmitting and receiving data and/or signals wirelessly. In certain embodiments, the antenna 810 is separate from the network node 800 and connectable to the network node 800 through an interface or port.

The antenna 810, the communication interface 806, and/or the processing circuitry 802 may be configured to perform any receiving operations and/or certain obtaining operations described herein as being performed by the network node 800. Any information, data, and/or signals may be received from a UE, another network node, and/or any other network equipment. Similarly, the antenna 810, the communication interface 806, and/or the processing circuitry 802 may be configured to perform any transmitting operations described herein as being performed by the network node 800. Any information, data, and/or signals may be transmitted to a UE, another network node, and/or any other network equipment.

The power source 808 provides power to the various components of the network node 800 in a form suitable for the respective components (e.g., at a voltage and current level needed for each respective component). The power source 808 may further comprise, or be coupled to, power management circuitry to supply the components of the network node 800 with power for performing the functionality described herein. For example, the network node 800 may be connectable to an external power source (e.g., the power grid or an electricity outlet) via input circuitry or an interface such as an electrical cable, whereby the external power source supplies power to power circuitry of the power source 808. As a further example, the power source 808 may comprise a source of power in the form of a battery or battery pack which is connected to, or integrated in, power circuitry. The battery may provide backup power should the external power source fail.

Embodiments of the network node 800 may include additional components beyond those shown in FIG. 8 for providing certain aspects of the network node's functionality, including any of the functionality described herein and/or any functionality necessary to support the subject matter described herein. For example, the network node 800 may include user interface equipment to allow input of information into the network node 800 and to allow output of information from the network node 800. This may allow a user to perform diagnostic, maintenance, repair, and other administrative functions for the network node 800.

FIG. 9 is a block diagram of a host 900, which may be an embodiment of the host 616 of FIG. 6, in accordance with various aspects described herein. As used herein, the host 900 may be or comprise various combinations of hardware and/or software including a standalone server, a blade server, a cloud-implemented server, a distributed server, a virtual machine, container, or processing resources in a server farm. The host 900 may provide one or more services to one or more UEs.

The host 900 includes processing circuitry 902 that is operatively coupled via a bus 904 to an input/output interface 906, a network interface 908, a power source 910, and memory 912. Other components may be included in other embodiments. Features of these components may be substantially similar to those described with respect to the devices of previous figures, such as FIGS. 7 and 8, such that the descriptions thereof are generally applicable to the corresponding components of the host 900.

The memory 912 may include one or more computer programs including one or more host application programs 914 and data 916, which may include user data, e.g., data generated by a UE for the host 900 or data generated by the host 900 for a UE. Embodiments of the host 900 may utilize only a subset or all of the components shown. The host application programs 914 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 914 may also provide for user authentication and licensing checks and may periodically report health, routes, and content availability to a central node, such as a device in or on the edge of a core network. Accordingly, the host 900 may select and/or indicate a different host for Over-The-Top (OTT) services for a UE. The host application programs 914 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

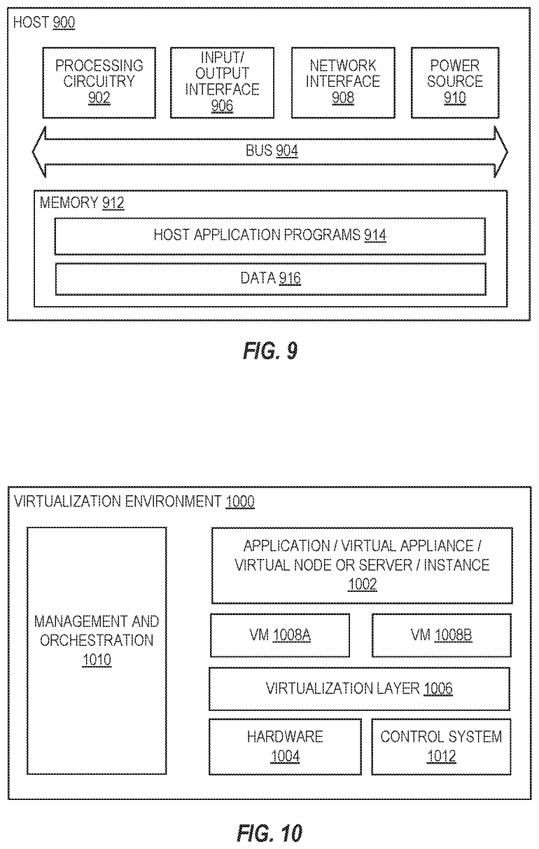

FIG. 10 is a block diagram illustrating a virtualization environment 1000 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 1000 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1002 (which may alternatively be called software instances, virtual appliances, network functions, virtual nodes, virtual network functions, etc.) are run in the virtualization environment 900 to implement some of the features, functions, and/or benefits of some of the embodiments disclosed herein.

Hardware 1004 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1006 (also referred to as hypervisors or VM Monitors (VMMs)), provide VMs 1008A and 1008B (one or more of which may be generally referred to as VMs 1008), and/or perform any of the functions, features, and/or benefits described in relation with some embodiments described herein. The virtualization layer 1006 may present a virtual operating platform that appears like networking hardware to the VMs 1008.

The VMs 1008 comprise virtual processing, virtual memory, virtual networking, or interface and virtual storage, and may be run by a corresponding virtualization layer 1006. Different embodiments of the instance of a virtual appliance 1002 may be implemented on one or more of the VMs 1008, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 1008 may be a software implementation of a physical machine that runs programs as if they were executing on a physical, non-virtualized machine. Each of the VMs 1008, and that part of the hardware 1004 that executes that VM, be it hardware dedicated to that VM and/or hardware shared by that VM with others of the VMs 1008, forms separate virtual network elements. Still in the context of NFV, a virtual network function is responsible for handling specific network functions that run in one or more VMs 1008 on top of the hardware 1004 and corresponds to the application 1002.

The hardware 1004 may be implemented in a standalone network node with generic or specific components. The hardware 1004 may implement some functions via virtualization. Alternatively, the hardware 1004 may be part of a larger cluster of hardware (e.g., such as in a data center or CPE) where many hardware nodes work together and are managed via management and orchestration 1010, which, among others, oversees lifecycle management of the applications 1002. In some embodiments, the hardware 1004 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a BS. In some embodiments, some signaling can be provided with the use of a control system 1012 which may alternatively be used for communication between hardware nodes and radio units.

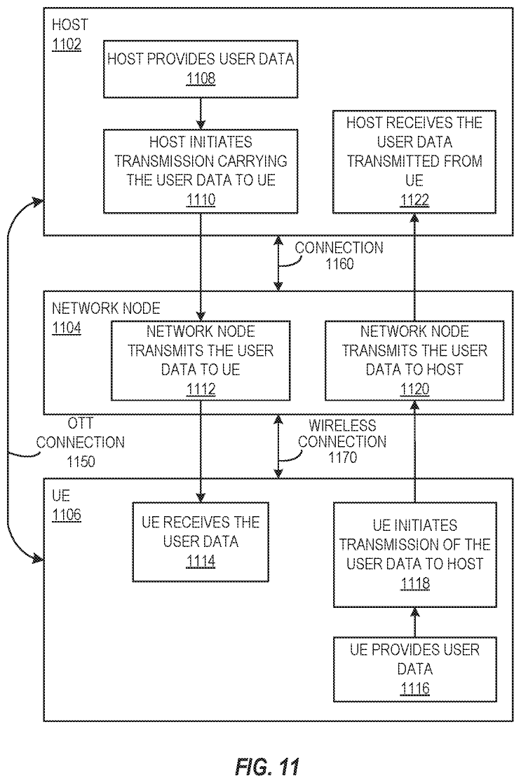

FIG. 11 shows a communication diagram of a host 1102 communicating via a network node 1104 with a UE 1106 over a partially wireless connection in accordance with some embodiments. Example implementations, in accordance with various embodiments, of the UE (such as the UE 612A of FIG. 6 and/or the UE 700 of FIG. 7), the network node (such as the network node 610A of FIG. 6 and/or the network node 800 of FIG. 8), and the host (such as the host 616 of FIG. 6 and/or the host 900 of FIG. 9) discussed in the preceding paragraphs will now be described with reference to FIG. 11.

Like the host 900, embodiments of the host 1102 include hardware, such as a communication interface, processing circuitry, and memory. The host 1102 also includes software, which is stored in or is accessible by the host 1102 and executable by the processing circuitry. The software includes a host application that may be operable to provide a service to a remote user, such as the UE 1106 connecting via an OTT connection 1150 extending between the UE 1106 and the host 1102. In providing the service to the remote user, a host application may provide user data which is transmitted using the OTT connection 1150.

The network node 1104 includes hardware enabling it to communicate with the host 1102 and the UE 1106 via a connection 1160. The connection 1160 may be direct or pass through a core network (like the core network 606 of FIG. 6) and/or one or more other intermediate networks, such as one or more public, private, or hosted networks. For example, an intermediate network may be a backbone network or the Internet.

The UE 1106 includes hardware and software, which is stored in or accessible by the UE 1106 and executable by the UE's processing circuitry. The software includes a client application, such as a web browser or operator-specific “app” that may be operable to provide a service to a human or non-human user via the UE 1106 with the support of the host 1102. In the host 1102, an executing host application may communicate with the executing client application via the OTT connection 1150 terminating at the UE 1106 and the host 1102. In providing the service to the user, the UE's client application may receive request data from the host's host application and provide user data in response to the request data. The OTT connection 1150 may transfer both the request data and the user data. The UE's client application may interact with the user to generate the user data that it provides to the host application through the OTT connection 1150.

The OTT connection 1150 may extend via the connection 1160 between the host 1102 and the network node 1104 and via a wireless connection 1170 between the network node 1104 and the UE 1106 to provide the connection between the host 1102 and the UE 1106. The connection 1160 and the wireless connection 1170, over which the OTT connection 1150 may be provided, have been drawn abstractly to illustrate the communication between the host 1102 and the UE 1106 via the network node 1104, without explicit reference to any intermediary devices and the precise routing of messages via these devices.

As an example of transmitting data via the OTT connection 1150, in step 1108, the host 1102 provides user data, which may be performed by executing a host application. In some embodiments, the user data is associated with a particular human user interacting with the UE 1106. In other embodiments, the user data is associated with a UE 1106 that shares data with the host 1102 without explicit human interaction. In step 1110, the host 1102 initiates a transmission carrying the user data towards the UE 1106. The host 1102 may initiate the transmission responsive to a request transmitted by the UE 1106. The request may be caused by human interaction with the UE 1106 or by operation of the client application executing on the UE 1106. The transmission may pass via the network node 1104 in accordance with the teachings of the embodiments described throughout this disclosure. Accordingly, in step 1112, the network node 1104 transmits to the UE 1106 the user data that was carried in the transmission that the host 1102 initiated, in accordance with the teachings of the embodiments described throughout this disclosure. In step 1114, the UE 1106 receives the user data carried in the transmission, which may be performed by a client application executed on the UE 1106 associated with the host application executed by the host 1102.

In some examples, the UE 1106 executes a client application which provides user data to the host 1102. The user data may be provided in reaction or response to the data received from the host 1102. Accordingly, in step 1116, the UE 1106 may provide user data, which may be performed by executing the client application. In providing the user data, the client application may further consider user input received from the user via an input/output interface of the UE 1106. Regardless of the specific manner in which the user data was provided, the UE 1106 initiates, in step 1118, transmission of the user data towards the host 1102 via the network node 1104. In step 1120, in accordance with the teachings of the embodiments described throughout this disclosure, the network node 1104 receives user data from the UE 1106 and initiates transmission of the received user data towards the host 1102. In step 1122, the host 1102 receives the user data carried in the transmission initiated by the UE 1106.

One or more of the various embodiments improve the performance of OTT services provided to the UE 1106 using the OTT connection 1150, in which the wireless connection 1170 forms the last segment. More precisely, the teachings of these embodiments may improve the e.g., data rate, latency, power consumption, etc. and thereby provide benefits such as e.g., reduced user waiting time, relaxed restriction on file size, improved content resolution, better responsiveness, extended battery lifetime, etc.

In an example scenario, factory status information may be collected and analyzed by the host 1102. As another example, the host 1102 may process audio and video data which may have been retrieved from a UE for use in creating maps. As another example, the host 1102 may collect and analyze real-time data to assist in controlling vehicle congestion (e.g., controlling traffic lights). As another example, the host 1102 may store surveillance video uploaded by a UE. As another example, the host 1102 may store or control access to media content such as video, audio, VR, or AR which it can broadcast, multicast, or unicast to UEs. As other examples, the host 1102 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 1150 between the host 1102 and the UE 1106 in response to variations in the measurement results. The measurement procedure and/or the network functionality for reconfiguring the OTT connection 1150 may be implemented in software and hardware of the host 1102 and/or the UE 1106. In some embodiments, sensors (not shown) may be deployed in or in association with other devices through which the OTT connection 1150 passes; the sensors may participate in the measurement procedure by supplying values of the monitored quantities exemplified above, or by supplying values of other physical quantities from which software may compute or estimate the monitored quantities. The reconfiguring of the OTT connection 1150 may include message format, retransmission settings, preferred routing, etc.; the reconfiguring need not directly alter the operation of the network node 1104. Such procedures and functionalities may be known and practiced in the art. In certain embodiments, measurements may involve proprietary UE signaling that facilitates measurements of throughput, propagation times, latency, and the like by the host 1102. The measurements may be implemented in that software causes messages to be transmitted, in particular empty or ‘dummy’ messages, using the OTT connection 1150 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device but are enjoyed by the computing device as a whole and/or by end users and a wireless network generally.

At least some of the following abbreviations may be used in this disclosure. If there is an inconsistency between abbreviations, preference should be given to how it is used above. If listed multiple times below, the first listing should be preferred over any subsequent listing(s).

Those skilled in the art will recognize improvements and modifications to the embodiments of the present disclosure. All such improvements and modifications are considered within the scope of the concepts disclosed herein.

1. A method performed by a User Equipment (UE) the method comprising:
receiving a configuration that indicates a full power mode of operation;
transmitting reference signals from each antenna port group of two or more antenna port groups;
receiving an indication to use a precoder for the full power mode transmission where the indicated precoder indicates a polarization and a spatial direction for each of the two or more antenna port groups; and
transmitting a single layer using the indicated precoder on the two or more antenna port groups.

2. The method of claim 1, wherein the indication to use a precoder comprises a Precoder Matrix Indicators (PMI) or a Transmit Precoder Matrix Indications (TPMI).

3. The method of claim 1, wherein the reference signals comprise Sounding Reference Signals (SRS).

4. The method of claim 1, wherein the UE is configured with a partially coherent codebook with two or four antenna groups.

5. The method of claim 1, wherein the UE comprises eight Tx partially coherent antennas.

6. The method of claim 1, wherein the precoder is from a set of precoders that take the spatial direction and polarization properties of the channel into account.

7. The method of claim 1, wherein the precoder is from one of different TPMIs/PMIs for the full power mode of operation are used for a partially coherent UE with four antenna groups and partially coherent UE with two antenna groups.

8. The method of claim 1, wherein a single precoder matrix is applied over all eight antenna ports.

9. The method of claim 1, wherein the precoder is from one of different TPMIs/PMIs where the different TPMIs/PMIs have different co-phasing factors between the four antenna ports belonging to the same antenna group.

10. The method of claim 1, wherein the precoder is from one of different TPMIs/PMIs, and where for each TPMI/PMI the polarization is the same for all antenna port groups, but for different TPMIs/PMIs, the polarization is different.

11. The method of claim 1, wherein the precoder is from one of different TPMIs/PMIs, and where for each TPMI/PMI the spatial direction is the same for all antenna port groups, but for different TPMIs/PMIs, the spatial direction is different.

12. The method of claim 1, wherein:
the precoder results in the same spatial direction for all antenna port groups, but for different antenna port groups the polarization is different; or
the precoder results in the same polarization for all antenna port groups, but for different antenna port groups the spatial direction is different; or
the precoder results in different polarizations and different spatial directions for different antenna port groups.

13-14. (canceled)

15. The method of claim 1, wherein the precoder is an 8-port TPMI/PMI that is divided into two 4-port TPMIs/PMIs.

16. The method of claim 1, wherein two separate fields in Downlink Control Information (DCI) are used to indicate TPMIs/PMIs, where a first field is used to indicate TPMI/PMI for a first antenna group and a second field is used to indicate TPMI/PMI for a second antenna group.

17. The method of claim 1, wherein the UE is equipped with 2 antenna groups, with 4 antennas in each group, and two “four-port TPMIs”, one per antenna group, are used to indicate a precoding matrix index and rank per antenna group.

18. The method of claim 1, further comprising receiving a DCI triggering a transmission; where the DCI comprises a single-bit bitfield, where the single-bit bitfield is used to indicate that single layer transmission should be applied over the two antenna groups.

19. (canceled)

20. The method of claim 1, further comprising one or more of:
signaling support for “Rel-18 power mode 1”;
explicitly signaling support for one, a subset, or all of the full power TPMIs/PMIs, associated with the “Rel-18 power mode 1”;
explicitly signaling support for one, a subset, or all of the ranks for which the UE supports full power associated with the “Rel-18 power mode 1”; and
signaling in UE capability if the UE supports full power mode 1 for one or more of: both four antenna groups and two antenna groups; only for two antenna groups; and only four antenna groups.

21. A method performed by a network node, the method comprising:
transmitting, to a User Equipment (UE) a configuration that indicates a full power mode of operation;
receiving, from the UE, reference signals from each antenna port group of two or more antenna port groups;
transmitting, to the UE, an indication to use a precoder for the full power mode transmission where the indicated precoder indicates a polarization and a spatial direction for each of the two or more antenna port groups; and
receiving, from the UE, a single layer using the indicated precoder on the two or more antenna port groups.

22-40. (canceled)

41. A User Equipment (UE) comprising processing circuitry and memory, the memory comprising instructions to cause the UE to:
receive a configuration that indicates a full power mode of operation;
transmit reference signals from each antenna port group of two or more antenna port groups;
receive an indication to use a precoder for the full power mode transmission where the indicated precoder indicates a polarization and a spatial direction for each of the two or more antenna port groups; and
transmit a single layer using the indicated precoder on the two or more antenna port groups.

42-43. (canceled)

44. A network node comprising processing circuitry and memory, the memory comprising instructions to cause the network node to:
transmit, to a User Equipment (UE) a configuration that indicates a full power mode of operation;
receive, from the UE, reference signals from each antenna port group of two or more antenna port groups;
transmit, to the UE, an indication to use a precoder for the full power mode transmission where the indicated precoder indicates a polarization and a spatial direction for each of the two or more antenna port groups; and
receive, from the UE, a single layer using the indicated precoder on the two or more antenna port groups.

45-46. (canceled)
